(19) United States
(12) Patent Application Publication
(10) Pub. No.: US 2010/0123092 A1
(43) Pub. Date: May 20, 2010

(54) FLUID CONTROL VALVE

(75) Inventors: Norio KOKUBO, Komaki-shi (JP); Hiroshi ITAFUJI, Komaki-shi (JP); Yasuhisa HIROSE, Komaki-shi (JP)

Correspondence Address: Beyer Law Group LLP, P.O. BOX 1687, Cupertino, CA, 95015-1687, US

(73) Assignee: CKD CORPORATION, Komaki-shi (JP)

(21) Appl. No.: 12/618,615

(22) Filed: Nov. 13, 2009

(30) Foreign Application Priority Data
Nov. 17, 2008 (JP) 2008-293867

(51) Int. Cl. F16K 31/08; F16K 11/07

(52) U.S. Cl. 251/129.01; 137/625.69

(57) ABSTRACT

A fluid control valve comprises a ferromagnetic material portion that is formed on the spool so as to extend in the axial direction of the spool, permanent magnets that are arranged opposite each other having the middle portion therebetween in a direction orthogonal to the axial direction of the spool, form between themselves oppositely oriented magnetic fields aligned in the axial direction, and which are formed to be longer than the middle portion in the axial direction of the spool, and a coil that is arranged in a direction orthogonal to the axial direction of the spool with respect to the permanent magnets and generates a magnetic field that penetrates the opposing permanent magnets due to the conduction of electricity.

The present application claims priority based on Japan Patent Application No. 2008-293867 filed on Nov. 17, 2008, and the entire contents of that application is incorporated by reference in this specification.

### FIELD OF THE INVENTION

The present invention relates to a fluid control valve that controls the flow of a fluid.

### BACKGROUND OF THE INVENTION

This type of fluid control valve will adjust the path dimensions of a fluid pathway by causing a spool housed inside a sleeve to slide (see, for example, Patent Document 1). As shown in FIG. 14, a fluid control valve 900 described in Patent Reference 1 slidably houses a spool 932 having different diameters in accordance with the positions in the axial direction, inside a cylindrical sleeve 931 in which a plurality of fluid pathways are formed that communicate with the exterior. A linear solenoid mechanism 911 that drives the spool 932 is arranged on one end of the spool 932 in the axial direction, and a spring housing chamber 943 is arranged on the other end of the spool 932 in the axial direction and a return spring 944 is housed in the fluid control valve 900. The return spring 944 urges the spool 932 toward the linear solenoid mechanism 911. The fluid control valve 900 controls the flow of fluid by causing the spool 932 to move against the urging force of the return spring 944 by means of the linear solenoid mechanism 911, and adjusting the position of the spool 932.

[Patent Document 1] Japan Published Patent Application No. 10-122412

### SUMMARY OF THE INVENTION

With the fluid control valve 900 disclosed in Patent Reference 1, lengthening of the fluid control valve 900 in the axial direction of the spool 932 cannot be avoided because the linear solenoid mechanism 911 is arranged on the spool 932 in the axial direction.

In addition, even with a fluid control valve comprising another drive mechanism such as an air cylinder, an electromotive cylinder, etc., lengthening of the fluid control valve in the axial direction of the spool cannot be avoided because these drive mechanisms are arranged in the axial direction of the spool.

In view of the aforementioned situation, a primary object of the present invention is to provide a fluid control valve that can shorten the length of the fluid control valve in the axial direction of the spool.

In order to solve the aforementioned problem, a first aspect of the invention comprises a fluid control valve comprising a sleeve member in which a plurality of fluid pathways that communicate with an exterior are formed, a column shaped spool which is slidably housed inside the sleeve member, and an urging means that urges the spool in the sliding direction, the fluid control valve adjusting the path dimensions of each of the fluid pathways by causing the spool to move in the axial direction thereof against the urging force of the urging means. The fluid control valve comprises a ferromagnetic portion that is formed on the spool so as to extend in the axial direction of the spool, permanent magnets arranged opposite each other having the ferromagnetic portion therebetween in a direction that is orthogonal to the axial direction of the spool, form an oppositely oriented magnetic field between the two that is aligned with the axial direction, and are formed to be longer in the axial direction of the spool than the ferromagnetic portion, and a coil that is arranged in a direction orthogonal to the axial direction of the spool with respect to the permanent magnets, and which generates a magnetic field that penetrates the opposing permanent magnets due to the conduction of electricity.

According to the first aspect of the invention, because a ferromagnetic portion that is formed on the spool so as to extend in the axial direction of the spool, and permanent magnets arranged opposite each other having the ferromagnetic portion therebetween in a direction that is orthogonal to the axial direction of the spool, form an oppositely oriented magnetic field between the two that is aligned with the axial direction, the ferromagnetic portion that extends in the axial direction will receive the magnetic force from the permanent magnets. In addition, because the permanent magnets are formed to be longer than the ferromagnetic material portion in the axial direction of the spool, the ferromagnetic material portion will be located within the range of the permanent magnets in the axial direction of the spool.

Here, because a coil is provided that is located in a direction orthogonal to the axial direction of the spool with respect to the permanent magnets, and generates a magnetic field that penetrates the opposing permanent magnets due to the conduction of electricity, one of the oppositely oriented magnetic fields aligned in the axial direction will be weakened and the other will be strengthened by causing a magnetic field to be generated that penetrates the opposing permanent magnets due to the conduction of electricity through the coil. Because of this, a magnetic force can be applied in the axial direction of the spool so as to move the ferromagnetic portion from the side in which the magnetic field was weakened to the side in which it was strengthened, and thus the spool can be moved against the urging force of the urging means. As a result, because the spool on which the ferromagnetic portion is formed is moved by conducting electricity through a coil that is arranged in a direction orthogonal to the axial direction thereof, there is no need to arrange a drive mechanism such as a coil or cylinder in the axial direction of the spool, and thus the length of the fluid control valve can be shortened in the axial direction of the spool. Note that adjusting the path dimensions of the fluid pathways includes continually enlarging or reducing the path dimensions of the fluid pathways, switching the state of the fluid pathways between fully open and fully closed, or others.

Because the permanent magnets are formed to be longer than the ferromagnetic portion in the axial direction of the spool, the ferromagnetic portion will be located within the range of the permanent magnets in the axial direction of the spool. Then, by conducing electricity through the coil, the ferromagnetic material portion will move along the length of the permanent magnets in the axial direction of the spool.

A second aspect of the invention is a fluid control valve according to the first aspect, in which, in a state in which electricity is not being conducted through the coil, the length from an end surface of the ferromagnetic portion to an end surface of the permanent magnets in one axial direction is set to be equal to the length that the spool will be slid in order to fully open or fully close at least one fluid pathway. Thus, by causing the ferromagnetic material portion to move in a range that is the length of the permanent magnets in the axial direction of the spool by conducing electricity through the coil, at least one of the fluid pathways can be easily adjusted to be fully open or fully closed.

A third aspect of the invention is a fluid control valve according to the first or second aspect, further comprises a magnetic path formation portion that comprises opposing portions that sandwich the opposing permanent magnets and the coil, and a connecting portion that connects the opposing portions on one side thereof along a surface that is orthogonal to the axial direction of the spool, and which guides the magnetic field generated due to the conduction of electricity through the coil to the permanent magnets, and the plurality of fluid pathways of the sleeve member have fluid pathways that pass between the spool and the connecting portion and communicate with the spool, and fluid pathways that communicate with the spool on the other side of the spool from the side toward the connecting portion side and communicate with the exterior on the side opposite to the connecting portion side behind the spool.

According to the third aspect of the invention, because a magnetic path formation portion is provided that comprises opposing portions that sandwich the opposing permanent magnets and the coil, and a connecting portion that connects the opposing portions on one side thereof along a surface that is orthogonal to the axial direction of the spool, and which guides the magnetic field generated due to the conduction of electricity through the coil to the permanent magnets, the force that causes the spool to move can be increased without extending the length of the fluid control valve in the axial direction of the spool.

Here, a magnetic path formation portion is not formed on the side opposite to the connecting portion side behind the spool. Because the plurality of fluid pathways of the sleeve member have fluid pathways that pass between the spool and the connecting portion and communicate with the spool, and fluid pathways that communicate with the spool on the other side of the spool from the side toward the connecting portion and communicate with the exterior on the side opposite to the connecting portion behind the spool, fluid pathways can be formed in the portion between the spool and the connecting portion, and the portion in which a magnetic path is not formed on the side opposite to the connecting portion side. As a result, the force that causes the spool to move can be increased by means of the magnetic path formation portion while efficiently arranging the fluid pathways.

A fourth aspect of the invention is a fluid control valve according to the first or second aspect, further comprises a magnetic path formation portion is provided that comprises opposing portions that sandwich the opposing permanent magnets and the coil, and connecting portions that connect the opposing portions via the end portion sides of the spool in the axial direction, and which guides the magnetic field generated due to the conduction of electricity through the coil to the permanent magnets, the plurality of fluid pathways of the sleeve member have fluid pathways that each communicate with both mutually opposing side surfaces of the spool in between the opposing permanent magnets, and each communicate with the exterior in a direction that is orthogonal to the axial direction of the spool.

According to the fourth aspect of the invention, because a magnetic path formation portion is provided that comprises opposing portions that sandwich the opposing permanent magnets and the coil, and connecting portions that connect the opposing portions via the end portion sides of the spool in the axial direction, and which guides the magnetic field generated due to the conduction of electricity through the coil to the permanent magnets, the length of the magnetic path can be shortened compared to when a drive mechanism for the spool is provided, even though the magnetic path formation portion is formed in the axial direction of the spool. Because the plurality of fluid pathways of the sleeve member have fluid pathways that each communicate with both mutually opposing side surfaces of the spool in between the opposing permanent magnets, and each communicate with the exterior in a direction that is orthogonal to the axial direction of the spool, fluid pathways can be formed that each communicate with the exterior in a orthogonal direction to the axial direction of the spool (a direction in which a magnetic path is not formed). As a result, the force that causes the spool to move can be increased by means of the magnetic path, and the flow resistance of the fluid can be reduced.

A fifth aspect of the invention is a fluid control valve according to any of the first to fourth aspects, in which the opposing permanent magnets are comprised of a pair of permanent magnets in which the magnetic poles thereof are oppositely oriented along the axial direction of the spool, and thus magnetic fields can be formed only by means of the pair of permanent magnets. As a result, the number of permanent magnets can be reduced, and the manufacturing cost of the fluid control valve can be lowered.

When the ferromagnetic portion is formed from a material that is different than other portions of the spool, those portions must be joined, and the strength of those joined portions may be reduced.

A sixth aspect of the invention is a fluid control valve according to any of the first to fifth aspects, in which a portion of the spool excluding the ferromagnetic portion is formed with an iron material that is not a ferromagnetic material, and the ferromagnetic portion is formed with a ferromagnetic material that is produced by annealing the iron material. Thus, by unitarily forming the spool with an iron material that is not a ferromagnetic material, and annealing only the portion to be made a ferromagnetic material, a ferromagnetic portion and another portion that is not a ferromagnetic material can be formed. As a result, the strength of the spool can be improved and the joining process can be omitted.

Because the spool is housed inside the sleeve member, the magnetic field must penetrate the sleeve member and be applied to the ferromagnetic portion of the spool. Because of this, when the sleeve member is formed with a ferromagnetic material, it will be difficult for a magnetic field to be applied to the ferromagnetic portion of the spool.

A seventh aspect of the invention is a fluid control valve according to any of the first to sixth aspects, in which the sleeve member is formed from a synthetic resin that is not a ferromagnetic material, and thus the magnetic field can penetrate the sleeve member and be applied to the ferromagnetic portion of the spool.

The above and other objects, features, and advantages of the present invention will be apparent from the following description when taken in conjunction with the accompanying drawings which illustrate preferred embodiments of the present invention by way of example.

### BRIEF DESCRIPTION OF DRAWINGS

FIG. 1 is a cross-sectional view showing the construction of a fluid control valve according to a first embodiment.

FIG. 2 is a front view showing the construction of the fluid control valve of FIG. 1.

FIG. 3 is a side view showing the construction of the fluid control valve of FIG. 1.

FIG. 4 is a cross-sectional view along line 4-4 of FIG. 1.

FIG. 5 is a cross-sectional view along line 5-5 of FIG. 2.

FIG. 6 is a front view showing the operation of the fluid control valve of FIG. 4.

FIG. 7 is a cross-sectional view showing the operation of the fluid control valve of FIG. 1.

FIG. 8 is a cross-sectional view showing the construction of a fluid control valve according to a second embodiment.

FIG. 9 is a cross-sectional view along line 9-9 of FIG. 8.

FIG. 10 is a cross-sectional view showing the construction of a fluid control valve according to a third embodiment.

FIG. 11 is a cross-sectional view along line 11-11 of FIG. 10.

FIG. 12 is a cross-sectional view showing the construction of a fluid control valve according to a fourth embodiment.

FIG. 13 is a cross-sectional view along line 13-13 of FIG. 12.

FIG. 14 is a cross-sectional view showing the construction of a conventional fluid control valve.

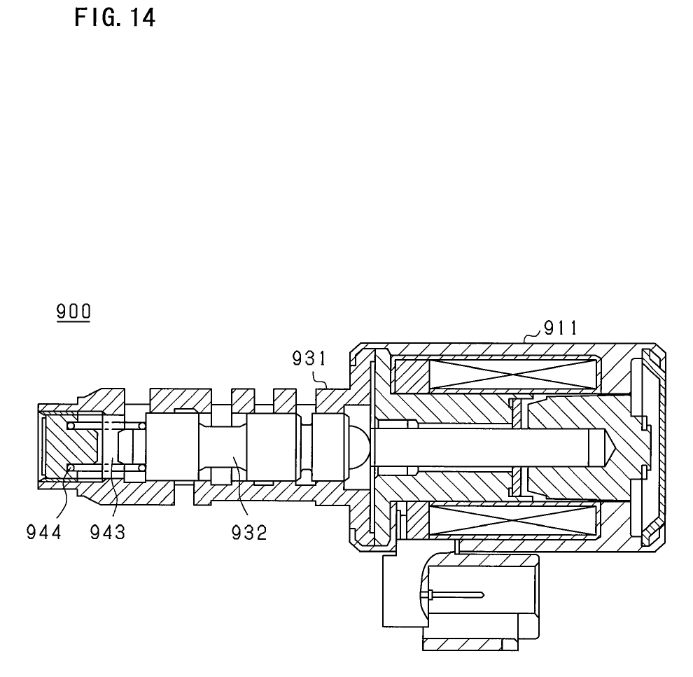

### DESCRIPTION OF THE PREFERRED EMBODIMENTS

### First Embodiment

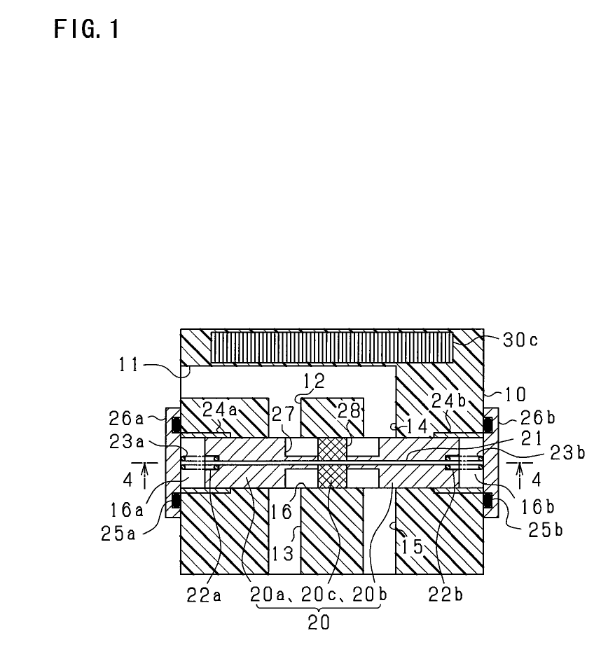

A first embodiment in which a fluid control valve according to the present invention is realized will be explained below with reference to the drawings. Note that FIG. 1 is a cross-sectional view that has been cut along a plane that includes the fluid pathways of the fluid control valve.

As shown in FIG. 1, the fluid control valve comprises a sleeve member 10 in which a cross section thereof forms a rectangular shape. A cylinder 16 that extends in the longer direction is formed near the central portion in the shorter direction of the sleeve member 10. The cylinder 16 passes through the sleeve member 10, and the openings thereof are sealed by O rings 25a and 25b and caps 26a and 26b. The sleeve member 10 is formed from a material other than a ferromagnetic material, e.g., formed from a synthetic resin that is not a ferromagnetic material.

A cylindrical spool 20 is slidably housed in the cylinder 16 along the axial line of the cylinder 16. The axial line of the cylinder 16 and the axial line of the spool 20 are the same. In the axial direction of the cylinder 16, the spool 20 is formed to be shorter than the cylinder 16, and the portions of the cylinder 16 that extend beyond both ends of the spool 20 are housing chambers 16a and 16b for springs 23a and 23b. Concave portions 22a and 22b are respectively formed in each end surface of the spool 20 in the axial direction. The end portions of the springs 23a and 23b that contact with the spool 20 are respectively fitted with the concave portions 22a and 22b. The spool 20 is urged with equal force in the axial direction by means of these springs 23a and 23b in opposite directions, and the position in which these urging forces are balanced is the neutral position of the spool 20. Note that the springs 23a and 23b comprise urging means that urge the spool in the sliding direction.

Slide bearings 24a and 24b are respectively arranged near both ends of the cylinder 16 in the axial direction, and slidably support the spool 20. In addition, a through hole 21 that passes through the central axis of the spool 20 is formed in the spool 20. When the spool 20 slides, fluid inside the housing chambers 16a and 16b will move from the high pressure area amongst housing chambers 16a and 16b to the low pressure area thereof. In this way, when the spool 20 slides, an increase in resistance due to the fluid inside the housing chambers 16a and 16b coming under pressure can be inhibited.

In addition, a supply pathway 11, a first discharge pathway 13, and a second discharge pathway 15 that respectively communicate with the exterior are formed in the sleeve member 10. The supply pathway 11 opens on a side surface of the sleeve member 10 perpendicular to the axial direction of the spool 20, and extends in a straight line between the spool 20 and a perpendicular portion 30c of a yoke described below. A first supply pathway 12 and a second supply pathway 14 that each perpendicularly communicate with the supply pathway 11 and the cylinder 16 are formed in sequence and in a straight line from the upstream side of the supply pathway 11. The first discharge pathway 13 and the second discharge pathway 15 are respectively formed in a straight line along lines that each extends from the first supply pathway 12 and the second supply pathway 14. The first discharge pathway 13 and the second discharge pathway 15 respectively communicate perpendicularly with the cylinder 16. In other words, the discharge pathways 13 and 15 both communicate with the spool 20 on the other side of the spool from the side toward the perpendicular portion 30c of the yoke and communicate with the exterior on the side opposite to the perpendicular portion 30c side behind the spool. The supply pathways 12 and 14 and the discharge pathways 13 and 15 are formed to be perpendicular to the perpendicular portion 30c of the yoke. The first supply pathway 12 and the second supply pathway 14 are formed to be parallel along the axial direction of the spool 20, and the first discharge pathway 13 and the second discharge pathway 15 are formed to be parallel along the axial direction of the spool 20. Thus, the supply pathway 11, the first supply pathway 12, the second supply pathway 14, the first discharge pathway 13, and the second discharge pathway 15 are formed along a plane that includes the central axis of the spool 20 and is perpendicular to the perpendicular portion 30c of the yoke. These pathways are formed to be circular and have the same diameters in any cross-section.

The spool 20 is comprised of end portions 20a and 20b arranged on the ends in the axial direction, and a middle portion 20c that lies between the end portions 20a and 20b and is arranged in the middle in the axial direction. The end portions 20a and 20b are formed from a material that is not a ferromagnetic material, and more specifically is formed from aluminum. The middle portion 20c is formed from a ferromagnetic material, and more specifically is formed from steel. Grooves 27 and 28 each having a width in the axial direction of the spool 20 that is approximately equal to the diameter of the supply pathways 12 and 14 are respectively formed in the outer circumferential surface of the end portions 20a and 20b of the spool 20. When the spool 20 is in the neutral position (the position of FIG. 1), half of the width of each of the grooves 27 and 28 is formed in a position that overlaps with the first supply pathway 12 and the second supply pathway 14. In the axial direction of the spool 20, the path dimensions of the grooves 27 and 28 will increase as the width that overlaps with each of the first supply pathway 12 and the second supply pathway 14 increases, and the volume of fluid that passes through the spool 20 and flows through the first discharge pathway 13 and the second discharge pathway 15 will increase. Thus, by adjusting the position of the spool 20 in the sliding direction (the axial direction), the volume of fluid that flows from the first supply pathway 12 to the first discharge pathway 13, and the volume of fluid that flows from the second supply pathway 14 to the second discharge pathway 15, can be controlled. Note that when one of the supply pathways 12 or 14 are fully open, the other will be fully closed, and when one of the supply pathways 12 or 14 are half open, the other will also be half open.

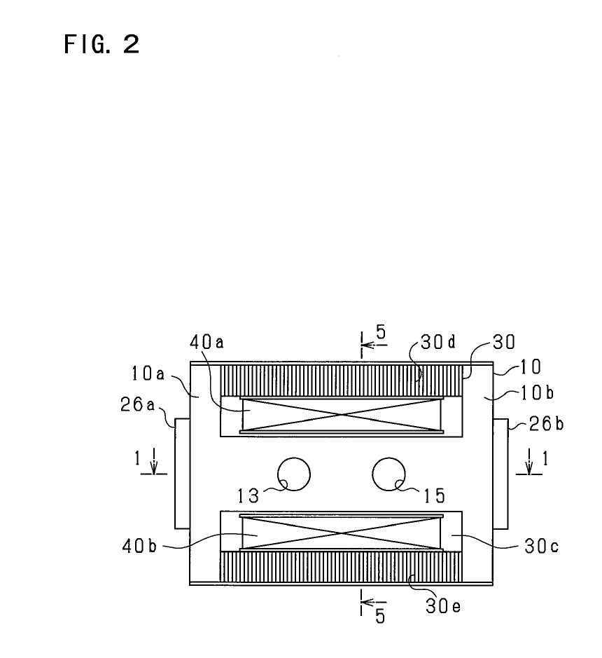

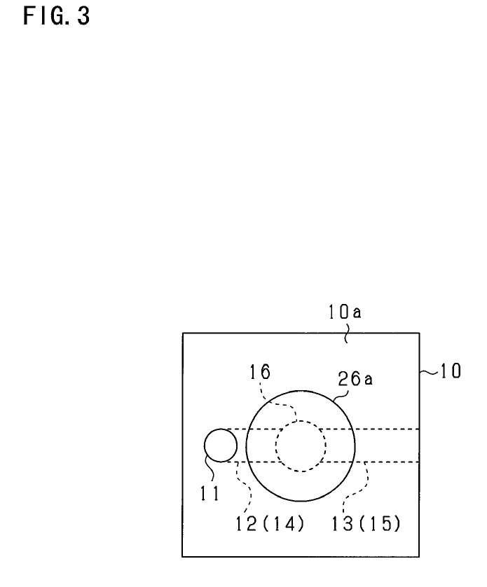

FIG. 2 is a front view which shows the fluid control valve as seen from the openings of the discharge pathways 13 and 15, and FIG. 3 is a side view which shows the fluid control valve as seen from the openings of the supply pathway 11.

As shown in FIGS. 2 and 3, on the sleeve member 10, rectangular plate shaped side wall portions 10a and 10b are arranged on both ends in the axial direction of the spool 20 so as to be perpendicular to that axial direction. In addition, opposing portions 30d and 30e are arranged on the yoke 30 so as to perpendicularly extend outward from the perpendicular portion 30c as a base end. Thus, between the side wall portion 10a and the side wall portion 10b, the opposing portion 30d and the opposing portion 30e are connected by the perpendicular portion 30c, and a magnetic path is formed by the yoke 30 comprised of these opposing portions 30d and 30e, and the perpendicular portion 30c. The opposing portions 30d and 30e and the perpendicular portion 30c are unitarily formed by steel plates that are layered in the axial direction of the spool 20.

A coil 40a is arranged between the opposing portion 30d and the cylinder 16 (spool 20) so that the axial direction is perpendicular to the opposing portion 30d, and a coil 40b is arranged between the opposing portion 30e and the cylinder 16 (spool 20) so that the axial direction is perpendicular to the opposing portion 30e. Thus, the coil 40a, the spool 20, and the coil 40b are sandwiched by the opposing portion 30d and the opposing portion 30e. The opposing portion 30d and the opposing portion 30e are arranged to be mutually parallel, and are parallel with respect to a plane that includes both central axes of the discharge pathways 13 and 15. In addition, the opposing portions 30d and 30e, the coils 40a and 40b, and the discharge pathways 13 and 15 are formed to be symmetrical along the axial direction of the coils 40a and 40b.

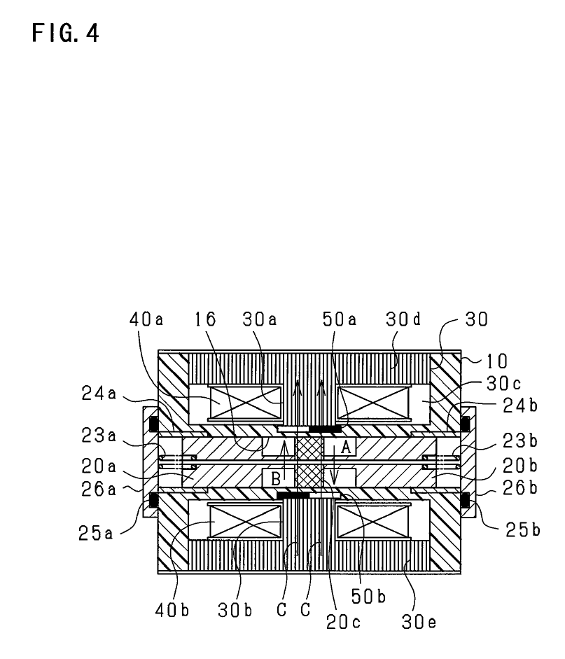

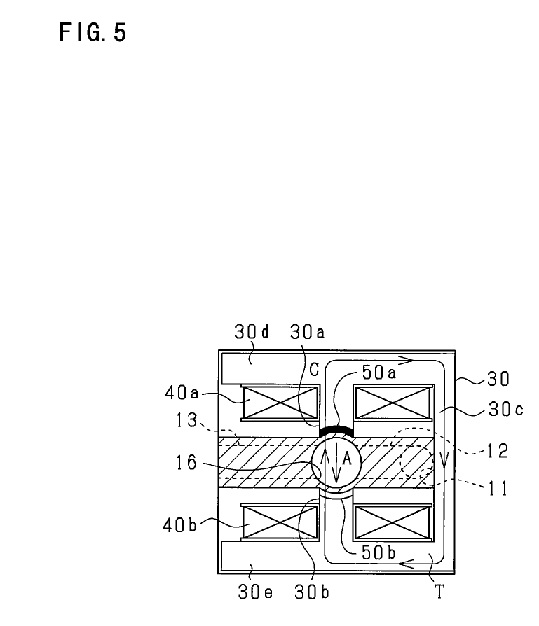

FIG. 4 shows a cross-section along line 4-4 of FIG. 1, and FIG. 5 shows a cross-section along line 5-5 of FIG. 2.

As shown in FIGS. 4 and 5, cylindrically shaped convex portions 30a and 30b are respectively formed near the center of opposing portions 30d and 30e of the yoke 30. The convex portions 30a and 30b extend to the vicinity of the cylinder 16, and the end surfaces thereof form an arc shape along the circumferential surface of the cylinder 16. The convex portions 30a and 30b are each formed to be integral and perpendicular with the opposing portions 30d and 30e. The convex portions 30a and 30b also extend perpendicularly with respect to the cylinder 16.

A permanent magnet 50a is arranged between the cylinder 16 and the convex portion 30a, and a permanent magnet 50b is arranged between the cylinder 16 and the convex portion 30b. The permanent magnets 50a and 50b are formed so as to extend in the axial direction of the spool 20 with an arc shaped cross-section along the circumferential surface of the cylinder 16 and respectively fixed to the end surfaces of the convex portion 30a and 30b. The permanent magnet 50a and the permanent magnet 50b are arranged on opposing sides of the middle portion 20c of the spool 20 in a direction that is orthogonal to the axial direction of the spool 20. The opposing pair of permanent magnets 50a and 50b is aligned so that the magnetic poles thereof are oppositely oriented along the axial direction of the spool 20. More specifically, the permanent magnet 50a is aligned along the axial direction of the spool 20 so that the end portion 20a side is the S pole and the end portion 20b side is the N pole, and the permanent magnet 50b is aligned along the axial direction of the spool 20 so that the end portion 20a side is the N pole and the end portion 20b side is the S pole. The permanent magnets 50a and 50b are both formed to have N pole portions and S pole portions that are of equal length in the axial direction of the spool 20. Thus, as shown by arrow A and arrow B, oppositely oriented magnetic fields are aligned in the axial direction of the spool 20 between the permanent magnet 50a and the permanent magnet 50b.

The convex portions 30a and 30b of the yoke 30 are each iron cores of the coils 40a and 40b, and the coils 40a and 40b are formed by wrapping conductive wire around the convex portions 30a, 30b. These coils 40a and 40b are arranged in a direction that is orthogonal to the axial direction of the spool 20 with respect to the permanent magnets 50a and 50b, and as shown by arrow C, a magnetic field that penetrates the oppositely oriented permanent magnets 50a and 50b and the middle portion 20c of the spool 20 will be generated by conducting electricity. In addition, by conducting electricity in a direction opposite this, the coils 40a and 40b will generate a magnetic field in a direction opposite the arrow C.

The yoke 30 comprises opposing portion 30d and opposing portion 30e that sandwich the opposing permanent magnets 50a and 50b and the coils 40a and 40b. The perpendicular portion 30c connects these opposing portions 30d and 30e along a surface T that is orthogonal to the axial direction of the spool 20 on one side (the side opposite to the cylinder 16 side across the supply pathway 11). In other words, a perpendicular portion that connects the opposing portions 30d and 30e is not arranged on the other side of these opposing portions 30d and 30e (the side opposite to the supply pathway 11 side behind the cylinder 16) along a surface T that is orthogonal to the axial direction of the spool 20. Because the yoke 30 is formed in this way, the magnetic field generated by the conduction of electricity through the coils 40a and 40b will be guided to the permanent magnets 50a and 50b as shown by arrow C. Note that the perpendicular portion 30c of the yoke 30 forms a connecting portion that connects the opposing portions 30d, 30e on one side thereof along a surface T that is orthogonal in the axial direction of the spool 20, and the yoke 30 forms a magnetic path formation portion that guides the magnetic field generated by conducting electricity through the coils 40a and 40b to the permanent magnets 50a and 50b.

In the axial direction of spool 20, the permanent magnets 50a and 50b are formed to be longer than the middle portion 20c of the spool 20 (the ferromagnetic portion). More specifically, the permanent magnets 50a and 50b are formed to be twice as long as the middle portion 20c. Thus, in the neutral state in which the middle portion 20c is positioned in the central portion of the permanent magnets 50a and 50b, one half of the middle portion 20c overlaps with the N pole and the other half overlaps with the S pole of the permanent magnets 50a and 50b in the axial direction of the spool 20. In a state in which the coils 40a and 40b are not conducting electricity, the length from the end surface of the middle portion 20c to the end surface of the permanent magnets 50a and 50b on the spring 23a side in the axial direction of spool 20 is set to be equal to the length in which the spool 20 will be slid in order for the first supply pathway 12 to be fully open and the second supply pathway to be fully closed. Thus, the area in which the middle portion 20c does not overlap with the permanent magnets 50a and 50b will become the area in which the middle portion 20c will move in the axial direction of the spool 20. In other words, the middle portion 20c will move in the axial direction of the spool 20 along the length of the permanent magnets 50a and 50b.

The synthetic resin of the sleeve material 10 that forms the inner wall of the cylinder 16 is between the permanent magnets 50a and 50b, and the middle portion 20c of the spool 20. In other words, the magnetic fields that are generated from the permanent magnets 50a and 50b and the coils 40a and 40b will penetrate the sleeve material 10 and be applied to the middle portion 20c of the spool 20. Because of this, the portion of the sleeve material 10 that is interposed between the permanent magnets 50a and 50b, and the middle portion 20c of the spool 20 is formed with the minimum thickness that allows the cylinder 16 to maintain rigidity in order for the magnetic field to efficiently penetrate.

In a state in which the coils 40a and 40b are not conducting electricity, a magnetic field shown with arrow C will not be generated, but the magnetic fields shown with arrow A and arrow B will be generated by the permanent magnets 50a and 50b. In this state, the end portions 20a and 20b that are formed from aluminum will not be affected by magnetic force. The middle portion 20c that is formed from steel will be affected by magnetic force, but that magnetic force will be balanced along the axial direction of the spool 20. In addition, due to the affects of the urging force of the springs 23a and 23b that urge the spool 20 in the sliding direction, the middle portion 20c will be positioned in the center of the permanent magnets 50a and 50b in the axial direction of the spool 20 when in the neutral state in which the coils 40a and 40b are not conducting electricity.

Next, the operation of the fluid control valve constructed as noted above will be explained.

When the spool 20 is to be moved in the axial direction, the direction of conducting electricity to the coils 40a and 40b and the size of the current thereof will be controlled. For example, when electricity is conducted through the coils 40a and 40b, and a magnetic field that passes in the direction from the permanent magnet 50b to the permanent magnet 50a is generated as shown with the arrow C, the magnetic field as shown with the arrow A from the N pole of the permanent magnet 50a toward the S pole of the permanent magnet 50b will be weakened, and the magnetic field as shown with the arrow B from the N pole of the permanent magnet 50b toward the S pole of the permanent magnet 50a will be strengthened.

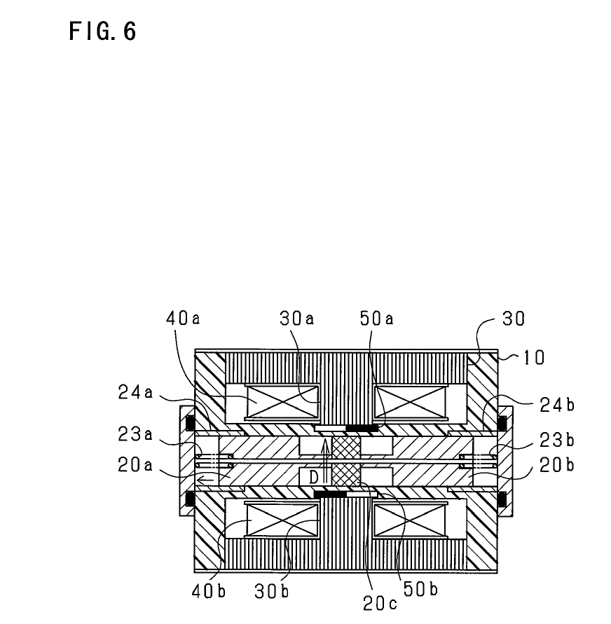

Then, for example, as shown in FIG. 6, between the permanent magnet 50a and the permanent magnet 50b, the magnetic field from the N pole of the permanent magnet 50a toward the S pole of the permanent magnet 50b will be extinguished, and a strong magnetic field shown with the arrow D will be formed from the N pole of the permanent magnet 50b toward the S pole of the permanent magnet 50a. This magnetic field will be applied to the middle portion 20c of the spool 20, which will apply a force to the spool 20 that will cause it to move toward the spring 23a in the axial direction.

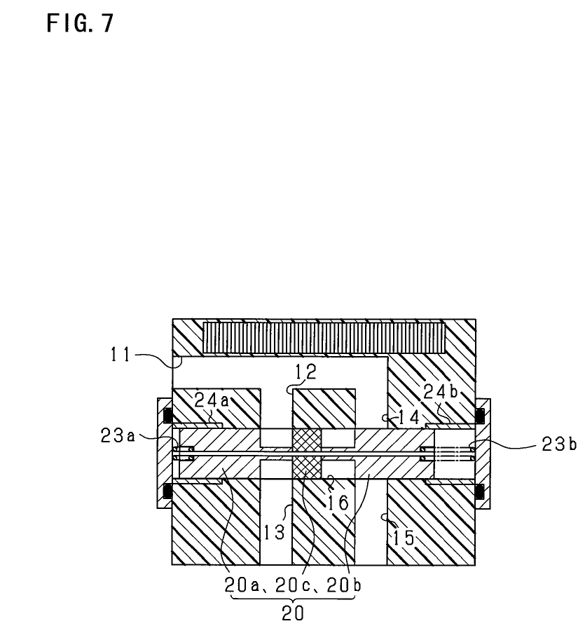

As a result, as shown in FIG. 7, the spool 20 will move against the urging force of the spring 23a in a direction in which the supply pathway 11 is open, the path dimensions of the first supply pathway 12 and the first discharge pathway 13 will become larger, and the path dimensions of the second supply pathway 14 and the second discharge pathway 15 will become smaller. Here, because the magnetic field generated will become stronger as the amount of electricity conducted through the coils 40a and 40b increases, the magnetic field from the N pole of the permanent magnet 50a toward the S pole of the permanent magnet 50b will become weaker, and the magnetic field from the N pole of the permanent magnet 50b toward the S pole of the permanent magnet 50a will become stronger. Thus, by controlling the amount of electricity conducted through the coils 40a and 40b, not only can the size of the magnetic force that causes the spool to move be controlled, but the amount of movement of the spool 20 can also be controlled.

In addition, when the spool 20 is to be moved toward the opposite side in the axial direction, the direction in which electricity is conducted through the coils 40a and 40b will be reversed, and by controlling the amount of electricity conducted, the amount of movement of the spool 20 can be controlled. In this way, the path dimensions of the supply pathways 12 and 14 can be adjusted and the amount of fluid controlled.

According to the construction of the present embodiment described in detail above, the following effects will be obtained.

A middle portion 20c (ferromagnetic portion) is provided that is formed on the spool 20 so as to extend in the axial direction of the spool 20, and permanent magnets 50a and 50b are provided opposite each other having the middle portion 20c of the spool 20 therebetween in a direction that is orthogonal to the axial direction of the spool 20 and form magnetic fields that are both aligned opposite each other in the axial direction (the magnetic fields shown with arrow A and arrow B in FIG. 4). Because of this, the middle portion 20c that extends in the axial direction of the spool 20 will receive the magnetic forces from the permanent magnets 50a and 50b. In addition, because the permanent magnets 50a and 50b are formed to be longer than the middle portion 20 in the axial direction of the spool 20, the middle portion 20c will be positioned within the range of the permanent magnets 50a and 50b in the axial direction of the spool 20.

Here, because coils 40a, 40b are provided in a direction orthogonal to the axial direction of the spool 20 with respect to the permanent magnets 50a and 50b and generate a magnetic field (the magnetic field shown with arrow C in FIG. 4) that passes through the opposing permanent magnets 50a and 50b, one of the oppositely oriented magnetic fields aligned in the axial direction will be weakened and the other will be strengthened by causing a magnetic field to be generated that passes through the opposing permanent magnets 50a and 50b due to the conduction electricity through the coils 40a and 40b. Because of this, a magnetic force can be applied so as to move the middle portion 20c from the side in which the magnetic field is weakened to the side in which it is strengthened in the axial direction of the spool 20, and the spool 20 can be moved against the urging force of the springs 23a and 23b. As a result, because the spool 20 on which the middle portion 20c is formed is moved by conducting electricity through coils 40a and 40b positioned in a direction orthogonal to the axial direction thereof, there is no need to arrange a drive mechanism such as a coil or cylinder in the axial direction of the spool 20, and thus the length of the fluid control valve in the axial direction of the spool 20 can be shortened.

Because the permanent magnets 50a and 50b are formed to be longer than the middle portion 20 in the axial direction of the spool 20, the middle portion 20c will be positioned within the range of the permanent magnets 50a and 50b in the axial direction of the spool 20. Thus, by conducting electricity through the coils 40a and 40b, the middle portion 20c will move in the axial direction of the spool 20 along the length of the permanent magnets 50a and 50b.

Here, in a state in which electricity is not being conducted through the coils 40a and 40b, the length from the end surface of the middle portion 20c to the end surfaces of the permanent magnets 50a and 50b in one axial direction of the spool 20 is set to be equal to the length in which the spool 20 will be slid in order to fully open or fully close at least one of the fluid pathways. Thus, by causing the middle portion 20c to be moved along the length of the permanent magnets 50a and 50b in the axial direction of the spool 20 by conducting electricity through the coils 40a and 40b, at least one of the fluid pathways can be easily adjusted to be fully open or fully closed.

Because the yoke 30 (magnetic path formation portion) comprises opposing portions 30d, 30e that sandwich the opposing permanent magnets 50a and 50b and the coils 40a and 40b, and a perpendicular portion 30c that links these opposing portions 30d and 30e on one side along a surface T that is orthogonal to the axial direction of the spool 20, and guides the magnetic field generated by conducting electricity through the coils 40a and 40b to the permanent magnets 50a and 50b, the force that causes the spool 20 to move can be increased without extending the length of the fluid control valve in the axial direction of the spool 20.

Here, a magnetic path is not formed on the side opposite to the perpendicular portion 30c side behind the spool 20. Thus, because a plurality of fluid pathways formed in the sleeve member 10 have supply pathways 11, 12 and 14 that pass between the spool 20 and the perpendicular member 30c and communicate with the spool 20, and discharge pathways 13 and 15 that both communicate with respect to the spool 20 on the other side from the side toward the perpendicular portion 30c and communicate with the exterior on the side opposite to the perpendicular portion 30c side behind the spool 20, fluid pathways can be formed in the portion between the spool 20 and the perpendicular portion 30c and the portion on the side opposite to the perpendicular portion 30c side in which a magnetic path is not formed. As a result, the force that causes the spool 20 to move can be increased by means of the yoke 30, and the fluid pathways can be efficiently located.

Because the permanent magnets arranged opposite each other are comprised of a pair of permanent magnets 50a and 50b in which their magnetic poles are arranged to be oppositely oriented along the axial direction of the spool 20, magnetic fields can be formed with only the pair of permanent magnets 50a and 50b. As a result, the number of permanent magnets can be reduced, and the manufacturing cost of the fluid control valve can be lowered.

Because the spool 20 is housed inside the sleeve member 10, the magnetic fields must penetrate the sleeve member 10 and be applied to the middle portion 20c (ferromagnetic portion) of the spool 20. Because of this, when the sleeve member 10 is formed with ferromagnetic material, it will be difficult for magnetic fields to be applied to the middle portion 20c of the spool 20.

According to the present embodiment, because the sleeve member 10 is formed from a synthetic resin which is not a ferromagnetic material, magnetic fields can penetrate the sleeve member 10 and be applied to the middle portion 20c of the spool 20. In addition, the portion of the sleeve material 10 that is interposed between the permanent magnets 50a and 50b and the middle portion 20c of the spool 20 is formed with the minimum thickness that allows the cylinder 16 to maintain rigidity in order for the magnetic fields to efficiently penetrate. Because of this, the magnetic fields applied to the middle portion 20c of the spool 20 can be increased, and it will not be necessary to provide permanent magnets having a large magnetic force or to increase the amount of electricity conducted through the coils.

### Second Embodiment

A second embodiment in which the fluid control valve according to the present invention is realized will be explained below with reference to the drawings. The second embodiment will be explained with focus on the points that differ with the first embodiment, and an explanation of the members that are identical with the first embodiment will be omitted by assigning the same reference number thereto.

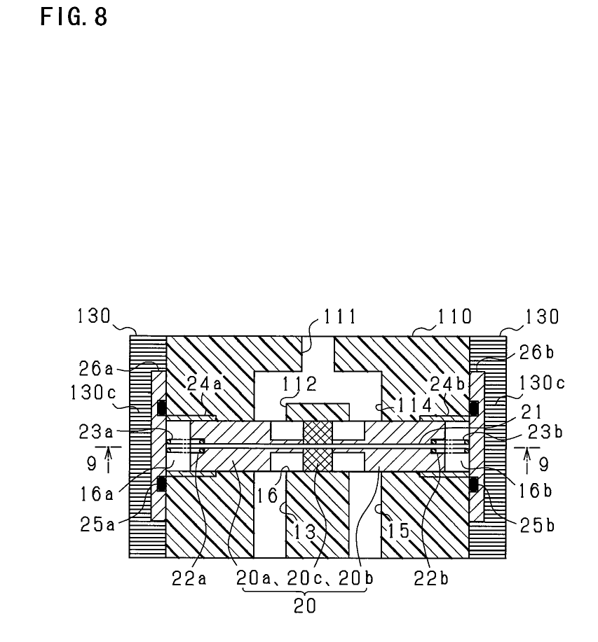

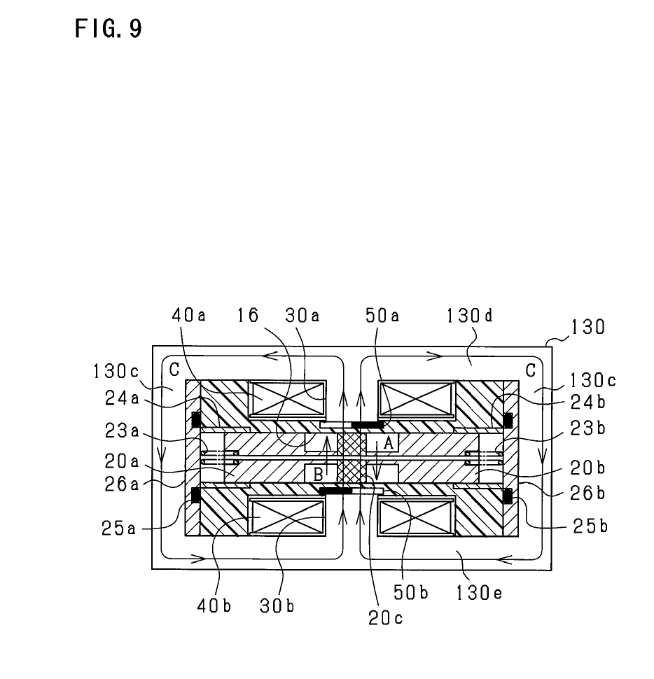

In the present embodiment, the construction of the yoke that forms the magnetic path and the construction of the fluid pathways that are formed in the sleeve member will be changed from the first embodiment. Note that FIG. 8 is a cross-sectional view that has been cut along a plane that includes the fluid pathways of the fluid control valve, and FIG. 9 is a cross-sectional view of line 9-9 of FIG. 8.

As shown in FIGS. 8 and 9, a supply pathway 111, a first supply pathway 112, a second supply pathway 114, a first discharge pathway 13, and a second discharge pathway 15 are formed in the sleeve member 110 so as to extend along the same plane between opposing permanent magnets 50a and 50b. The supply pathway 111 communicates with the exterior in a direction that is orthogonal to the axial direction of spool 20. The supply pathways 112 and 114 each communicate with the supply pathway 111, and each communicate perpendicularly to the cylinder 16 (the spool 20). The supply pathway 112 and the discharge pathway 13 communicate with both opposing side surfaces of the spool 20, and the supply pathway 114 and the discharge pathway 15 communicate with both opposing side surfaces of the spool 20. In other words, the supply pathway 112 and the discharge pathway 13 communicate with the spool 20 on mutually opposing sides thereof, and the supply pathway 114 and the discharge pathway 15 communicate with the spool 20 on mutually opposing sides thereof. The first discharge pathway 13 and the second discharge pathway 15 are formed in a straight line along lines that respectively extend from the first supply pathway 112 and the second supply pathway 114. The supply pathways 13 and 15 each communicate with the exterior in a direction that is orthogonal to the axial direction of spool 20. Note that these pathways are formed to be circular and have the same diameters in any cross-section.

The yoke 130 is formed so as to connect opposing portions 130d and 130e via the end portion sides of the spool 20 in the axial direction. More specifically, the yoke 130 comprises opposing portion 130d and opposing portion 130e that sandwich the permanent magnets 50a and 50b and the coils 40a and 40b. The opposing portions 130d and 130e are each formed into a rectangular plate shape that is perpendicular to the axial direction of the coils 40a and 40b. The perpendicular portions 130c (connecting portions) connect these opposing portion 130d and 130e via both end portion sides of the spool 20 in the axial direction. A magnetic path is formed by the yoke 130 comprised of these opposing portions 130d and 130e and the perpendicular portion 130c. These opposing portions 130d and 130e and the perpendicular portion 130c are unitarily formed by steel plates that are layered in the direction in which the discharge pathways 13 and 15 extend. Because the yoke 130 is formed in this way, a magnetic field generated by the conduction of electricity through the coils 40a and 40b will flow through the permanent magnets 50a and 50b as shown by arrow C.

According to the construction of the present embodiment noted in detail above, in addition to the effects according to the first embodiment, the following unique effects will be obtained.

Because the yoke 130 comprises opposing portions 130d and 130e that sandwich the opposing permanent magnets 50a and 50b and the coils 40a and 40b, and perpendicular portions 130c that connect these opposing portions 130d and 130e via the end portion sides of the spool 20 in the axial direction, and guides the magnetic field generated by conducting electricity through the coils 40a and 40b to the permanent magnets 50a and 50b, the length of the yoke 130 can be shorter than when a drive mechanism of the spool 20 is provided, even though the perpendicular portions 130c of the yoke 130 are provided in the axial direction of the spool 20. Thus, because the plurality of fluid pathways of the sleeve member 110 each communicate with both opposing side surfaces of the spool 20 between the opposing permanent magnets 50a and 50b, and have the supply pathway 111 and the discharge pathways 13 and 15 that each communicate with the exterior in the direction orthogonal to the axial direction of the spool 20, fluid pathways can be formed that each communicate with the exterior in a orthogonal direction to the axial direction of the spool 20 in which a magnetic path is not formed. As a result, the force that causes the spool 20 to move can be increased by means of the yoke 130, and the flow resistance of the fluid can be reduced.

Because the perpendicular portions 130c of the yoke 130 are formed on both end portion sides of the spool 20 in the axial direction, the magnetic field can be efficiently guided compared to when the perpendicular portion 130c was formed on only one end portion side. As a result, the force that causes the spool 20 to move can be increased even more.

### Third Embodiment

A third embodiment in which the fluid control valve according to the present invention is realized will be explained below with reference to the drawings. The third embodiment will be explained with focus on the points that differ with the first embodiment, the same reference numbers will be applied to the same members in the first embodiment, and an explanation of the members that are identical with the first embodiment will be omitted by assigning reference numbers that have 200 added thereto.

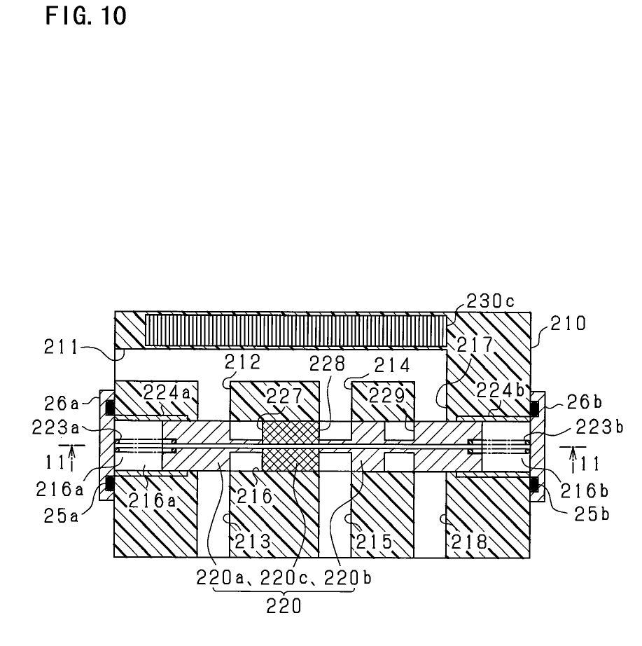

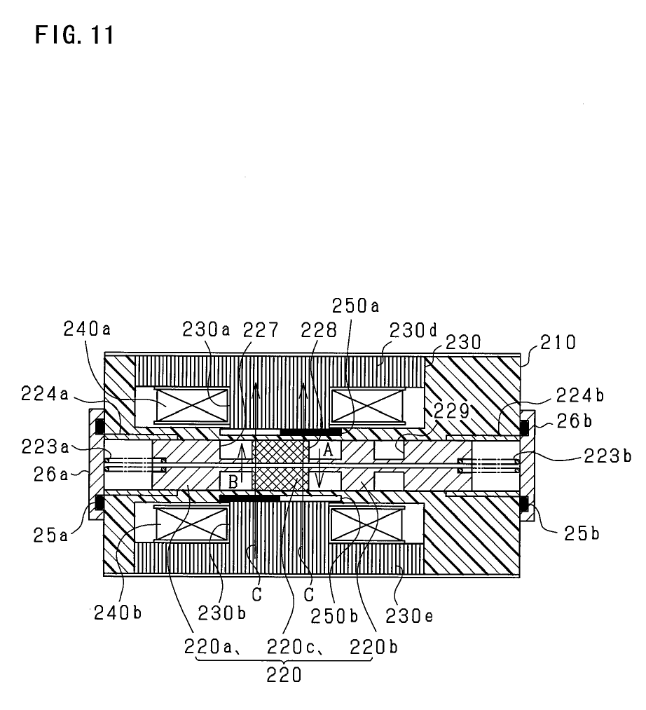

In the present embodiment, the construction of the fluid pathways that are formed in the sleeve member and the construction of the spool that adjusts the path dimensions thereof will be changed from the first embodiment. Note that FIG. 10 is a cross-sectional view that has been cut along a plane that includes the fluid pathways of the fluid control valve, and FIG. 11 is a cross-sectional view of line 11-11 of FIG. 10.

As shown in FIGS. 10 and 11, a supply pathway 211, a first discharge pathway 213, a second discharge pathway 215 and a third discharge pathway 218 that respectively communicate with the exterior are formed in a sleeve member 210. The supply pathway 211 opens on a side surface of the sleeve member 210 perpendicular to the axial direction of the spool 220, and extends in a straight line between the spool 220 and a perpendicular portion 230c of a yoke 230. A first supply pathway 212, a second supply pathway 214, and a third supply pathway 217 that each perpendicularly communicate with the supply pathway 211 and the cylinder 216 are formed in sequence and in a straight line from the upstream side of the supply pathway 211. The first discharge pathway 213, the second discharge pathway 215, and the third discharge pathway 218 are formed in a straight line along respective lines that extend from the first supply pathway 212, the second supply pathway 214 and the third supply pathway 217. The first discharge pathway 213, the second discharge pathway 215, and the third discharge pathway 216 perpendicularly communicate with the cylinder 216, respectively. In other words, the discharge pathways 213, 215 and 218 communicate with the spool 220 on the other side of the spool from the side toward the perpendicular portion 230c of the yoke 230, and communicate with the exterior on the side opposite to the perpendicular portion 230c side behind the spool 220.

The supply pathways 212, 214 and 217 and the discharge pathways 213, 215 and 218 are formed to be perpendicular with respect to the perpendicular portion 230c of the yoke 230. The first supply pathway 212, the second supply pathway 214, and the third supply pathway 217 are formed side by side and aligned in the axial direction of the spool 220, and the first discharge pathway 213, the second discharge pathway 215, and the third discharge pathway 218 are formed side by side and aligned in the axial direction of the spool 220. Thus, the supply pathway 211, the first supply pathway 212, the second supply pathway 214, the third supply pathway 217, the first discharge pathway 213, the second discharge pathway 215 and the third discharge pathway 218 are formed along a plane that includes the central axis of the spool 220 and that is perpendicular to the perpendicular portion 230c of the yoke 230. These pathways are formed to be circular and have the same diameters in any cross-section.

The spool 220 is comprised of end portions 220a and 220b arranged on the ends in the axial direction, and a middle portion 220c that lies between the end portions 220a and 220b and is arranged in the middle in the axial direction. The end portions 220a and 220b are formed from a material that is not a ferromagnetic material, and more specifically are formed from aluminum. The middle portion 220c is formed from a ferromagnetic material, and more specifically is formed from steel. A groove 227 is formed in the outer circumferential surface of the end portion 220a of the spool 220 and the width thereof in the axial direction of the spool 220 is approximately equivalent to the diameter of the supply pathway 212. Grooves 228, 229 are respectively formed in the outer circumferential surface of the end portion 220b and their widths in the axial direction of the spool 220 thereof are approximately equivalent to the diameters of the supply pathways 214 and 217. In order to close the second supply pathway 214, the middle portion 220c in the axial direction of the spool portion 220 must have a width that is equivalent to the diameter of the supply pathway 214. Here, the width of the middle portion 220c in the axial direction of the spool 220 is formed to be larger than the diameter of the supply pathway 214, and more specifically, formed to be approximately two times the diameter of the supply pathway 214. When the spool 220 is in the neutral position (the positions shown in FIGS. 10 and 11), the first supply pathway 212 and the third supply pathway 217 will be fully closed, and the second supply pathway 214 will be fully open. Thus, path dimensions will increase in the axial direction of the spool 220 as the widths of the grooves 227-229 that overlap with each supply pathway increase, and the quantity of fluid that passes through the spool 220 and flows into each discharge pathway will increase. Thus, by adjusting the position in the sliding direction (axial direction) of the spool 220, the quantity of fluid that flows through each pathway can be controlled.

In the axial direction of spool 220, the permanent magnets 250a and 250b are formed to be longer than the middle portion 220c of the spool 220 (the ferromagnetic portion). More specifically, the permanent magnets 250a and 250b are formed to be twice as long as the middle portion 220c. Thus, in the neutral state in which the middle portion 220c is positioned in the central portion of the permanent magnets 250a and 250b, one half of the middle portion 220c overlaps with the N pole and the other half overlaps with the S pole of the permanent magnets 250a and 250b in the axial direction of the spool 220. Furthermore, half of the S pole of the permanent magnet 250a will overlap in the axial direction of the spool 220 so as to match the groove 227 of the spool 220 and half of the N pole thereof will overlap so as to match the groove 228 of the spool 220. In addition, half of the N pole of the permanent magnet 250b will overlap in the axial direction of the spool 220 so as to match the groove 227 of the spool 220 and half of the S pole thereof will overlap so as to match the groove 228 of the spool 220. In a state in which electricity is not being conducted to coils 240a and 240b, the length from the end surface of the middle portion 220c to the end surface of the permanent magnets 250a and 250b on the spring 223a side in the axial direction of spool 220 is set to be equal to the length in which the spool 220 will be slid in order for the first supply pathway 212 to be fully open and the second supply pathway to be fully closed. In a state in which electricity is not being conducted to the coils 240a and 240b, the length from the end surface of the middle portion 220c to the end surface of the permanent magnets 250a and 250b on the spring 223b side in the axial direction of spool 220 is set to be equal to the length in which the spool 220 will be slid in order for the second supply pathway 214 to be fully closed and the third supply pathway 217 to be fully open.

Then, the area in which the middle portion 220c does not overlap with the permanent magnets 250a and 250b will become the area in which the middle portion 220c will move in the axial direction of the spool 220. In other words, the middle portion 220c will move in the axial direction of the spool 220 along the length of the permanent magnets 250a and 250b. Due to the effects of the urging force of the springs 223a and 223b that urge the spool 220 in the sliding direction, the middle portion 220c will be positioned in the center of the permanent magnets 250a and 250b in the axial direction of the spool 220 in a neutral state in which electricity is not being conducted to the coils 240a and 240b.

According to the construction of the present embodiment noted in detail above, in addition to the effects according to the first embodiment, the following unique effects will be obtained.

Half of the S pole of the permanent magnet 250a will overlap in the axial direction of the spool 220 so as to match the groove 227 of the spool 220 and half of the N pole thereof will overlap so as to match the groove 228 of the spool 220. In addition, half of the N pole of the permanent magnet 250b will overlap in the axial direction of the spool 220 so as to match the groove 227 of the spool 220 and half of the S pole thereof will overlap so as to match the groove 228 of the spool 220. Thus, because the middle portion 220c will move in the axial direction of the spool 22 along the length of the permanent magnets 250a and 250b, the spool 220 can be moved the width of the grooves 227 and 228 by conducting electricity through the coils 240a and 240b, and the supply pathways 212, 214 and 217 can each be adjusted from fully closed to fully open.

In order to close the second supply pathway 214, the middle portion 220c in the axial direction of the spool portion 220 must have a width that is equivalent to the diameter of the supply pathway 214. In the present embodiment, the width of the middle portion 220c in the axial direction of the spool 220 is formed to be larger than the diameter of the supply pathway 214, and more specifically, formed to be approximately two times the diameter of the supply pathway 214, and thus a magnetic field that penetrates the middle portion 220c can be received in a wider range. As a result, the force that causes the spool 220 to move can be increased even more.

### Fourth Embodiment

A fourth embodiment in which the fluid control valve according to the present invention is realized will be explained below with reference to the drawings. The second embodiment will be explained with focus on the points that differ with the first embodiment, and an explanation of the members that are identical with the first embodiment will be omitted by assigning the same reference number thereto.

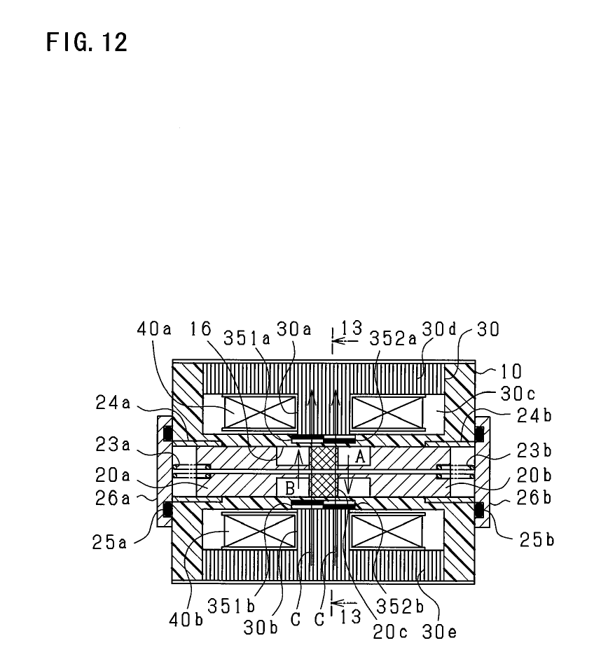

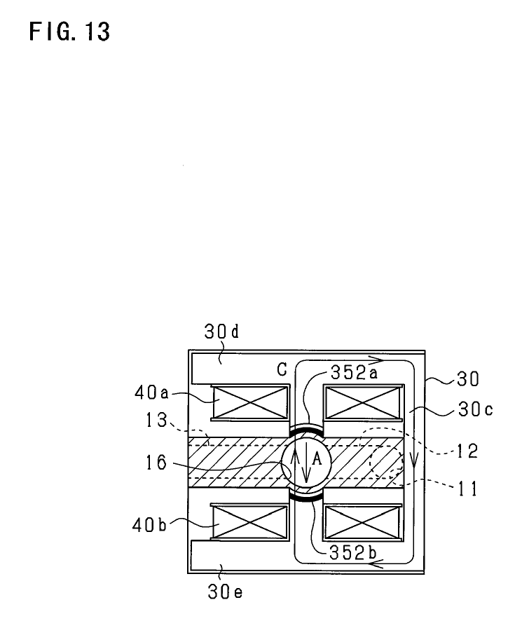

In the present embodiment, the construction of the permanent magnets will be changed from the first embodiment. Note that FIG. 12 is a cross-sectional view that has been cut along a perpendicular plane that includes the fluid pathways of the fluid control valve, and FIG. 13 is a cross-sectional view of line 13-13 of FIG. 12.

As shown in FIGS. 12 and 13, permanent magnets 351a and 352a are arranged between the cylinder 16 and the convex portion 30a, and permanent magnets 351b and 352b are arranged between the cylinder 16 and the convex portion 30b. These permanent magnets are formed so as to be arc shaped in cross-section along the circumferential surface of the cylinder 16 and to extend in the axial direction of the spool 20, and are respectively fixed to the end surfaces of convex portions 30a and 30b that are formed so as to extend in the axial direction with the same arc shape. The permanent magnet 351a and the permanent magnet 351b are located opposite each other having the middle portion 20c of the spool 20 therebetween in a direction orthogonal to the axial direction of the spool 20, and the permanent magnet 352a and the permanent magnet 352b are located opposite each other having the middle portion 20c of the spool 20 therebetween in a direction orthogonal to the axial direction of the spool 20. The permanent magnet 351a and the permanent magnet 352a are aligned with each other in the axial direction of the spool 20, and the permanent magnet 351b and the permanent magnet 352b are aligned with each other in the axial direction of the spool 20.

These permanent magnets are all radial anisotropic permanent magnets in which the magnetic poles have been arranged in a orthogonal direction to the axial direction of the spool 20. The permanent magnet 351a and the permanent magnet 352a are aligned such that the magnetic poles thereof oppose each other, and more specifically, the spool 20 side of the permanent magnet 351a is the S pole, and the spool 20 side of the permanent magnet 352a is the N pole. The permanent magnet 351b and the permanent magnet 352b are aligned such that the magnetic poles thereof oppose each other, and more specifically, the spool 20 side of the permanent magnet 351b is the N pole, and the spool 20 side of the permanent magnet 352b is the S pole. The permanent magnets 351a and 352a are formed such that the lengths thereof are equal in the axial direction of the spool 20, and the permanent magnets 351b and 352b are formed such that the lengths thereof are equal in the axial direction of the spool 20. Thus, a magnetic field is formed from the N pole of the permanent magnet 352a to the S pole of the permanent magnet 352b as shown with the arrow A, and a magnetic field is formed from the N pole of the permanent magnet 351b to the S pole of the permanent magnet 351a as shown with the arrow B. In other words, magnetic fields that are aligned in the axial direction of the spool 20 and are oppositely oriented are formed by these permanent magnets.

In the axial direction of the spool 20, the total length of the permanent magnets 351a, 352a, and the total length of the permanent magnets 351b, 352b, are each formed to be longer than the middle portion 20c (the ferromagnetic portion). More specifically, the permanent magnets 351a, 352a, 351b and 352b are together formed to be equal in length to the middle portion 20. Thus, in the axial direction of the spool 20, the middle portion 20c overlaps with half of each permanent magnet 351a, 352a, 351b and 352b when in the neutral state, in which the middle portion 20c is positioned on the boundary between the permanent magnet 351a and the permanent magnet 352a (the permanent magnet 351b and the permanent magnet 352b). Thus, the area in which the middle portion 20c does not overlap with the permanent magnets 351a and 351b and the area in which the middle portion 20c does not overlap with the permanent magnets 352a and 352b are the areas in which the middle portion 20c will move in the axial direction of the spool 20. In other words, the middle portion 20c will slide in an area the length of the permanent magnet 351a and the permanent magnet 352a (the permanent magnet 351b and the permanent magnet 352b) in the axial direction of the spool 20.

According to the construction of the present embodiment described in detail above, effects in accordance with the first embodiment will be obtained.

The present invention is not limited to the aforementioned embodiment, and may for example be implemented as follows.

In each of the aforementioned embodiments, a cylindrical spool was adopted, but a square pole shaped spool and the like, or a column shaped spool having another shape in cross-section can also be adopted.

In each of the aforementioned embodiments, slide bearings were respectively arranged near both end portions of the cylinder in the axial direction, but instead of these slide bearings, a member having little slide resistance can be unitarily arranged on the outer circumference of both end portions of the spool, or the slide bearing can be omitted.

In each of the aforementioned embodiments, the path dimensions of the fluid pathways were designed to be continually enlarged or reduced as one mode of adjustment. However, the fluid pathway state may instead be switched between fully open and fully closed.

In each of the aforementioned embodiments, the end portions 20a and 20b of the spool 20 and the end portions 220a and 220b of the spool 220 were formed from aluminum, which is not a ferromagnetic material. However, if these are located in positions in which the effects of the magnetic fields generated by the permanent magnets and coils can be ignored, ferromagnetic portions may be included on the end portions of the spool.

In the aforementioned second embodiment, the perpendicular portions 130c of the yoke 130 was formed on both end portion sides of the spool 20 in the axial direction. However, a perpendicular portion 130c of the yoke 130 can also be formed on only one end portion side of the spool 20 in the axial direction. In addition, the perpendicular portion 130c of the yoke 130 can also be omitted. According to this construction, although the force that causes the spool 20 to move will be reduced, the length of the fluid control valve in the axial direction of the spool 20 can be shortened.

In each of the aforementioned embodiments, the coils were located opposite each other having the spool and the permanent magnets therebetween. However, the coils can also be arranged in only one of the directions orthogonal to the axial direction of the spool with respect to the permanent magnets. Even in this case, a force that causes the spool to move can be ensured by means of a construction comprising a magnetic path formation portion that guides a magnetic field generated by conducing electricity through the coils to the permanent magnets.

In each of the aforementioned embodiments, the supply pathways and the discharge pathways were formed along a plane that includes the central axis of the spool and that is perpendicular to the yoke, i.e., a plane that is parallel to the opposing portions of the yoke. However, the supply pathways and the discharge pathways may be formed along a plane that is diagonal with respect to this plane if between the opposing permanent magnets. In addition, the supply pathways and the discharge pathways need not necessarily be formed along a specific plane.

In each of the aforementioned embodiments, a fluid pathway that branches into a plurality of supply pathways from one supply pathway was adopted, but a fluid pathway comprised of a plurality of independent supply pathways can also be adopted. In this case, as with the second embodiment, by providing opposing portions that sandwich the opposing permanent magnets and the coils, and a magnetic path formation portion that comprises a connecting portion that connects these opposing portions via the end portion sides of the spool in the axial direction, each of the supply pathways can be formed in a straight line between the opposing permanent magnets and can each communicate with the exterior in a orthogonal direction to the axial direction of the spool (a direction in which a magnetic path is not formed). As a result, the force that causes the spool to move can be increased by means of the magnetic path formation portion, and the flow resistance of the fluid can be reduced.

In each of the aforementioned embodiments, the present invention was realized as a fluid control valve that causes fluid to pass through the spool 20 from the supply pathway 11 side and flow toward the discharge pathways 13 and 15, or a fluid control valve that causes fluid to pass through the spool 20 from the supply pathway 111 side and flow toward the discharge pathways 13 and 15. However, with the same construction, the present invention can be realized as a fluid control valve that causes fluid to pass through the spool 20 from the discharge pathway 13 and 15 side and flow toward the supply pathway 11 side, or a fluid control valve that causes fluid to pass through the spool 20 from the discharge pathway 13 and 15 side and flow toward the supply pathway 111 side.

In each of the aforementioned embodiments, the sleeve members 10, 110 and 210 were formed from a synthetic resin that is not a ferromagnetic material, but can also be formed from a metal such as aluminum or the like that is not a ferromagnetic material.

In each of the aforementioned embodiments, because the middle portion 20c of the spool 20 is formed with a ferromagnetic material and the end portions 20a and 20b are formed with aluminum, or the middle portion 220c of the spool 220 is formed with a ferromagnetic material and the end portions 220a and 220b are formed with aluminum, a middle portion and end portions comprising different materials must be joined together. In contrast to this, by forming the middle portion and the end portions from an iron material that is not a ferromagnetic material, and annealing only the middle portion, the middle portion can be made into a ferromagnetic material and the end portions can be a material that is not a ferromagnetic material. According to this construction, because the middle portion and the end portions are unitarily formed, strength can be improved and the joining process can be omitted.

1. In a fluid control valve comprising a sleeve member in which a plurality of fluid pathways that communicate with an exterior are formed, a column shaped spool which is slidably housed inside the sleeve member, and an urging means that urges the spool in the sliding direction, the fluid control valve adjusting the path dimensions of each of the fluid pathways by causing the spool to move in the axial direction thereof against the urging force of the urging means, the fluid control valve comprising;
a ferromagnetic portion that is formed on the spool so as to extend in the axial direction of the spool,
permanent magnets arranged opposite each other having the ferromagnetic portion therebetween in a direction that is orthogonal to the axial direction of the spool, form an oppositely oriented magnetic field between the two that is aligned with the axial direction, and are formed to be longer in the axial direction of the spool than the ferromagnetic portion, and
a coil that is arranged in a direction orthogonal to the axial direction of the spool with respect to the permanent magnets, and which generates a magnetic field that penetrates the opposing permanent magnets due to the conduction of electricity.

2. The fluid control valve according to claim 1, wherein in a state in which electricity is not being conducted through the coil, the length from an end surface of the ferromagnetic portion to an end surface of the permanent magnets in one axial direction is set to be equal to a length that the spool will be slid in order to fully open or fully close at least one fluid pathway.

3. The fluid control valve according to claim 1, further comprising a magnetic path formation portion that comprises opposing portions that sandwich the opposing permanent magnets and the coil, and a connecting portion that connects the opposing portions on one side thereof along a surface that is orthogonal to the axial direction of the spool, and which guides the magnetic field generated due to the conduction of electricity through the coil to the permanent magnets, and the plurality of fluid pathways of the sleeve member have fluid pathways that pass between the spool and the connecting portion and communicate with the spool, and fluid pathways that communicate with the spool on the other side of the spool from the side toward the connecting portion and communicate with the exterior on the side opposite to the connecting portion side behind the spool.

4. The fluid control valve according to claim 1, further comprising a magnetic path formation portion that comprises opposing portions that sandwich the opposing permanent magnets and the coil, and connecting portions that connect the opposing portions via the end portion sides of the spool in the axial direction, and which guides the magnetic field generated due to the conduction of electricity through the coil to the permanent magnets, the plurality of fluid pathways of the sleeve member have fluid pathways that each communicate with both mutually opposing side surfaces of the spool in between the opposing permanent magnets, and each communicate with the exterior in a direction that is orthogonal to the axial direction of the spool.

5. The fluid control valve according to claim 1, wherein the opposing permanent magnets are comprised of a pair of permanent magnets in which the magnetic poles thereof are oppositely oriented along the axial direction of the spool.

6. The fluid control valve according to claim 1, wherein a portion of the spool excluding the ferromagnetic portion is formed with an iron material that is not a ferromagnetic material, and the ferromagnetic portion is formed with a ferromagnetic material that is produced by annealing the iron material.

7. The fluid control valve according to claim 1, wherein the sleeve member is formed from a synthetic resin that is not a ferromagnetic material.

8. The fluid control valve according to claim 2, further comprising a magnetic path formation portion that comprises opposing portions that sandwich the opposing permanent magnets and the coil, and a connecting portion that connects the opposing portions on one side thereof along a surface that is orthogonal to the axial direction of the spool, and which guides the magnetic field generated due to the conduction of electricity through the coil to the permanent magnets, and
the plurality of fluid pathways of the sleeve member have fluid pathways that pass between the spool and the connecting portion and communicate with the spool, and fluid pathways that communicate with the spool on the other side of the spool from the side toward the connecting portion and communicate with the exterior on the side opposite to the connecting portion side behind the spool.

9. The fluid control valve according to claim 2, further comprising a magnetic path formation portion that comprises opposing portions that sandwich the opposing permanent magnets and the coil, and connecting portions that connect the opposing portions via the end portion sides of the spool in the axial direction, and which guides the magnetic field generated due to the conduction of electricity through the coil to the permanent magnets,
the plurality of fluid pathways of the sleeve member have fluid pathways that each communicate with both mutually opposing side surfaces of the spool in between the opposing permanent magnets, and each communicate with the exterior in a direction that is orthogonal to the axial direction of the spool.

10. The fluid control valve according to claim 2, wherein the opposing permanent magnets are comprised of a pair of permanent magnets in which the magnetic poles thereof are oppositely oriented along the axial direction of the spool.

11. The fluid control valve according to claim 2, wherein a portion of the spool excluding the ferromagnetic portion is formed with an iron material that is not a ferromagnetic material, and the ferromagnetic portion is formed with a ferromagnetic material that is produced by annealing the iron material.

12. The fluid control valve according to claim 2, wherein the sleeve member is formed from a synthetic resin that is not a ferromagnetic material.

13. The fluid control valve according to claim 3, wherein the opposing permanent magnets are comprised of a pair of permanent magnets in which the magnetic poles thereof are oppositely oriented along the axial direction of the spool.

14. The fluid control valve according to claim 3, wherein a portion of the spool excluding the ferromagnetic portion is formed with an iron material that is not a ferromagnetic material, and the ferromagnetic portion is formed with a ferromagnetic material that is produced by annealing the iron material.

15. The fluid control valve according to claim 3, wherein the sleeve member is formed from a synthetic resin that is not a ferromagnetic material.

16. The fluid control valve according to claim 4, wherein the opposing permanent magnets are comprised of a pair of permanent magnets in which the magnetic poles thereof are oppositely oriented along the axial direction of the spool.

17. The fluid control valve according to claim 4, wherein a portion of the spool excluding the ferromagnetic portion is formed with an iron material that is not a ferromagnetic material, and the ferromagnetic portion is formed with a ferromagnetic material that is produced by annealing the iron material.

18. The fluid control valve according to claim 4, wherein the sleeve member is formed from a synthetic resin that is not a ferromagnetic material.
